(19) United States
(12) Patent Application Publication
(10) Pub. No.: US 2024/0063510 A1
(43) Pub. Date: Feb. 22, 2024

(54) SECONDARY BATTERY

(71) Applicant: SK On Co., Ltd., Seoul (KR)

(72) Inventors: Kyu Beom KIM, Daejeon (KR); Keun Jun LEE, Daejeon (KR)

(21) Appl. No.: 18/346,858

(22) Filed: Jul. 5, 2023

(30) Foreign Application Priority Data
Aug. 16, 2022 (KR) 10-2022-0102018

(51) Int. Cl. H01M 50/474; H01M 50/105; H01M 50/483; H01M 50/486; H01M 50/477

(52) U.S. Cl. CPC H01M 50/474; H01M 50/105; H01M 50/483; H01M 50/486; H01M 50/477

(57) ABSTRACT

To prevent damage to an exterior material accommodating an electrode assembly, the present disclosure provides a secondary battery comprising an electrode assembly; an exterior material accommodating the electrode assembly, and a protective member disposed inside the exterior material and surrounding a vertex of the electrode assembly.

### CROSS-REFERENCE TO RELATED PATENT APPLICATION

The present application claims priority under 35 U.S.C. § 119(a) to Korean patent application number 10-2022-0102018 filed on Aug. 16, 2022, in the Korean Intellectual Property Office, the entire disclosure of which is incorporated by reference herein.

### BACKGROUND OF THE INVENTION

### 1. Field

The present disclosure relates to a secondary battery comprising a protective member for preventing damage to an exterior material accommodating an electrode assembly.

### 2. Description of the Related Art

The electric vehicle market requires the production of batteries that allow driving long distances on a single charge. The energy density of the battery should be high to increase the driving range a vehicle. Lithium secondary batteries are most suitably used as batteries for electric vehicles because they exhibit high energy density.

A lithium secondary battery is manufactured by accommodating an electrode assembly in an exterior material. The electrode assembly comprises an electrode where an electrical reaction occurs. FIG. 1 is a schematic diagram of a conventional electrode assembly and a structure of a conventional secondary battery in which the electrode assembly is accommodated in an exterior material. Referring to FIG. 1, a conventional secondary battery 100 comprises an electrode assembly 10 accommodated in an exterior material 11. Generally, an electrode assembly 10 has a rectangular parallelepiped shape. Therefore, the vertex A portion of the electrode assembly 10 has a sharp shape. For this reason, when the electrode assembly 10 is accommodated in the exterior material 11, the exterior material area A′ that is in contact with the vertex A portion of the electrode assembly 10 is damaged. In addition, when the exterior material 11 is damaged, the electrolyte leaks, the secondary battery ignites, or the performance of the secondary battery deteriorates. Therefore, as a technology for improving the stability and performance of secondary batteries, it is required to prevent damage to an exterior material accommodating an electrode assembly.

### SUMMARY OF THE INVENTION

One exemplary technical problem of the present invention is to provide a secondary battery capable of preventing damage to an exterior material accommodating an electrode assembly.

A secondary battery according to one Embodiment of the present invention comprises an electrode assembly, an exterior material accommodating the electrode assembly, and a protective member disposed inside the exterior material and surrounding a vertex of the electrode assembly.

According to an Embodiment, an inner surface of the protective member may contact with a vertex of the electrode assembly.

According to an Embodiment, an outer surface of the protective member may contact with the exterior material.

According to an Embodiment, an inner surface of the protective member may comprise a shape corresponding to the vertex.

According to an Embodiment, an outer surface of the protective member may comprise a curved shape.

According to an Embodiment, the protective member may comprise at least one among a thermoplastic resin, a thermosetting resin, a rubber resin, a non-conductive metal alloy, and a non-conductive ceramic.

According to an Embodiment, the protective member may be made of a transparent material.

According to an Embodiment, the electrode assembly may comprise a plurality of edges.

According to an Embodiment, the secondary battery may further comprise a supplementary member surrounding at least one edge among the plurality of edges.

According to an Embodiment, the protective member and the supplementary member may be integrally formed.

According to an Embodiment, an inner surface of the supplementary member may comprise a shape corresponding to the edge.

According to an Embodiment, an outer surface of the supplementary member may comprise a curved shape.

According to an Embodiment, the width of the supplementary member may be within a range of 5 mm to 50 mm.

According to an Embodiment, an angle formed by the protective member and the supplementary member may be greater than 90 degrees and less than 180 degrees.

According to an Embodiment, the supplementary member may surround an edge in the thickness direction of the electrode assembly.

According to an Embodiment, the supplementary member may surround an edge in the length direction of the electrode assembly.

According to an Embodiment, the supplementary member may surround an edge in the width direction of the electrode assembly and an edge in the length direction of the electrode assembly.

According to an Embodiment, the supplementary member may surround an edge in the thickness direction of the electrode assembly and an edge in the length direction of the electrode assembly.

According to an Embodiment, the supplementary member may comprise at least one among a thermoplastic resin, a thermosetting resin, a rubber resin, a non-conductive metal alloy, and a non-conductive ceramic.

According to an Embodiment, the supplementary member may be made of a transparent material.

A secondary battery according to one Embodiment of the present invention can reduce the risk of damage to an exterior material due to a sharp vertex of an electrode assembly.

In addition, a secondary battery according to one Embodiment of the present invention can reduce the risk of damage to an exterior material due to a sharp vertex and an edge of an electrode assembly.

In addition, a secondary battery according to one Embodiment of the present invention can reduce the risk of damage to an exterior material and at the same time, maintain the performance thereof.

In addition, a secondary battery according to one Embodiment of the present invention can reduce leakage of an electrolyte, ignition of the secondary battery, or deterioration of the performance of the secondary battery due to damage to an exterior material.

### BRIEF DESCRIPTION OF THE DRAWINGS

FIG. 1 is a schematic diagram of a conventional electrode assembly and a structure of a conventional secondary battery in which the electrode assembly is accommodated in an exterior material.

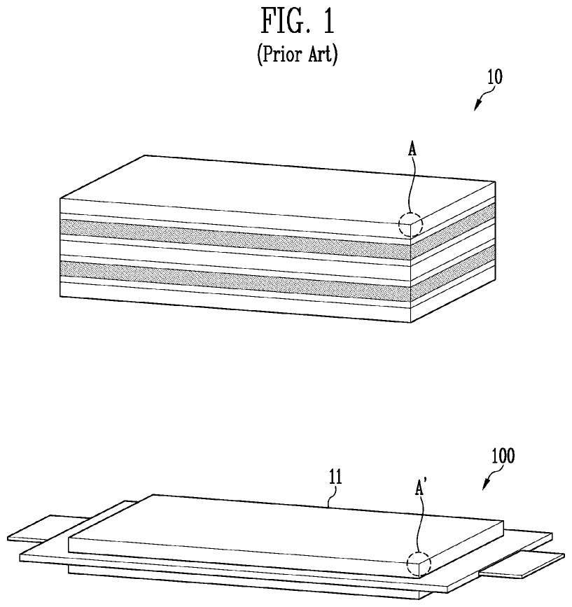

FIG. 2 is a schematic diagram of an electrode assembly in which a protective member is formed and a structure of a secondary battery in which the electrode assembly is accommodated in an exterior material according to one Embodiment of the present invention.

FIG. 3 is a schematic diagram of a structure of an electrode assembly in which a protective member is formed according to one Embodiment of the present invention.

FIG. 4 is a schematic diagram of a structure of an electrode assembly in which a protective member made of a transparent material is formed according to one Embodiment of the present invention.

FIG. 5 is a schematic diagram of a structure of an electrode assembly in which a protective member and a supplementary member are formed according to one Embodiment of the present invention.

FIG. 6 is an enlarged diagram of an outer surface, a left surface, a right surface, and an inner surface of a structure of a protective member and a supplementary member integrally configured according to one Embodiment of the present invention.

FIG. 7 is a schematic diagram of a protective member and a supplementary member formed in the thickness direction of an electrode assembly according to one Embodiment of the present invention.

FIG. 8 is a schematic diagram of a protective member and a supplementary member formed in the length direction of an electrode assembly according to one Embodiment of the present invention.

FIG. 9 is a schematic diagram of a protective member and a supplementary member formed in the width direction and in the length direction of an electrode assembly according to one Embodiment of the present invention.

FIG. 10 is a schematic diagram of a protective member and a supplementary member formed in the thickness direction and in the length direction of an electrode assembly according to one Embodiment of the present invention.

FIG. 11 is a schematic diagram of a structure of an electrode assembly in which a protective member made of a transparent material and a supplementary member made of a transparent material are formed according to one Embodiment of the present invention.

### DETAILED DESCRIPTION

Structural or functional descriptions of Embodiments disclosed in the present specification or application are merely illustrated for the purpose of describing Embodiments according to the technical principle of the present disclosure.

Embodiments according to the technical principle of the present disclosure may be implemented in various forms other than the Embodiments disclosed in the present specification or application.

The technical principle of the present disclosure is not to be construed as being limited to the Embodiments described in this specification or application.

The present invention is explained in detail below.

A secondary battery according to one Embodiment of the present invention comprises an electrode assembly and an exterior material accommodating the electrode assembly. A secondary battery according to one Embodiment of the present invention further comprises a protective member disposed inside the exterior material and surrounding a vertex of the electrode assembly.

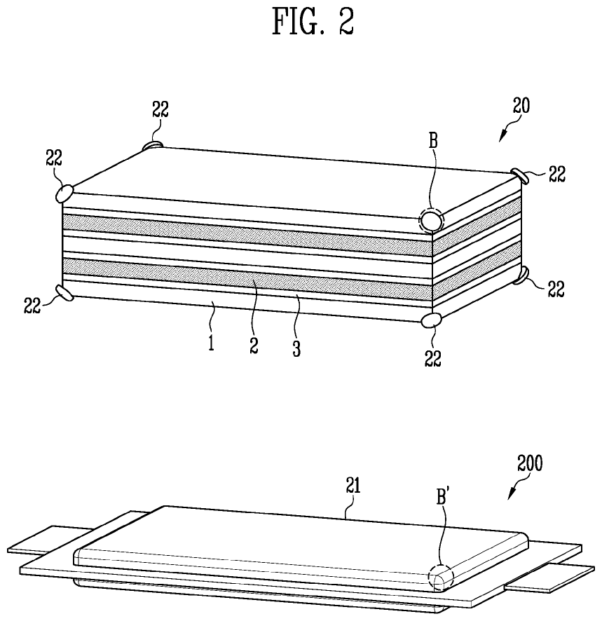

FIG. 2 is a schematic diagram of an electrode assembly having a protective member and a structure of a secondary battery in which the electrode assembly is accommodated in an exterior material according to one Embodiment of the present invention. Referring to FIG. 2, a secondary battery 200 comprises an electrode assembly 20 and an exterior material 21 accommodating the electrode assembly 20.

The electrode assembly 20 may comprise a structure in which a cathode 1, an anode 2, and a separator 3 interposed between the cathode 1 and the anode 2 are stacked. The cathode 1 may comprise a cathode active material into which lithium (Li) ions can be intercalated and deintercalated. The anode 2 may comprise an anode active material into which lithium (Li) ions can be intercalated and deintercalated. In addition, the cathode 1 and the anode 2 may further comprise a binder and a conductive material in each of a cathode active material and an anode active material to improve mechanical stability and electrical conductivity. The separator 3 may be configured to prevent an electrical short between the cathode 1 and the anode 2 and to generate an ion flow. The type of the separator 3 is not particularly limited, but may comprise a porous polymer film. The electrode assembly 20 may be manufactured by stacking or zigzag stacking in which a plurality of cathodes 1 and anodes 2 are alternately stacked and a separator is interposed between the cathodes 1 and the anodes 2.

The exterior material 21 plays the role of protecting the electrode assembly 20 from an external environment. The exterior material 21 may comprise a water resistant resin. The exterior material 21 may have, for example, a film form in which a polyolefin-based resin, a metal, a nylon resin, and a polyethylene terephthalate resin are stacked.

The secondary battery 200 comprises a protective member 22, wherein the protective member 22 is disposed inside the exterior material 21 and surrounds a vertex of the electrode assembly 20.

According to an Embodiment, the protective member 22 may comprise an inner surface and an outer surface. An inner surface of the protective member 22 may contact with a vertex of the electrode assembly 20. An outer surface of the protective member 22 may contact with the exterior material 21. When the protective member 22 is formed in the electrode assembly 20, an area B′ of an exterior material that is in contact with a vertex B portion of the electrode assembly may have a curved shape. As a result, an exterior material 21 may not be damaged by a sharp vertex of an electrode assembly 20, and thus leakage of an electrolyte, ignition of a secondary battery, or deterioration of the performance of a secondary battery can be prevented.

According to an Embodiment, an inner surface of the protective member 22 may comprise a shape corresponding to a vertex of the electrode assembly 20. According to an Embodiment, an outer surface of the protective member 22 may comprise a curved shape.

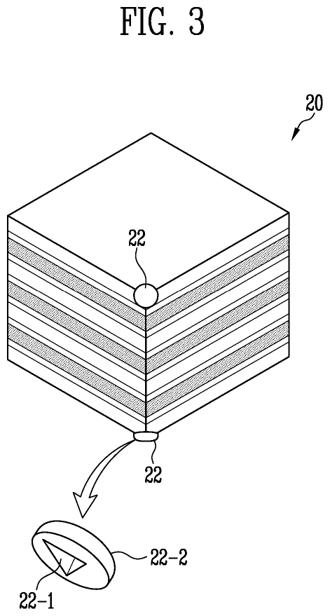

FIG. 3 is a schematic diagram of a structure of an electrode assembly in which a protective member is formed according to one Embodiment of the present invention. Referring to FIG. 3, an inner surface 22-1 of the protective member 22 may have a shape corresponding to a vertex of the electrode assembly 20. The description that an inner surface 22-1 of the protective member 22 comprises a shape corresponding to a vertex of the electrode assembly 20 means that the inner surface 22-1 of the protective member 22 comprises a shape that can accommodate a vertex of the electrode assembly 20. The description that an inner surface 22-1 of the protective member 22 comprises a shape corresponding to a vertex of the electrode assembly 20 does not mean that the size and shape of the inner surface 22-1 of the protective member 22 are exactly the same as the size and shape corresponding to a vertex of the electrode assembly 20. In addition, an inner surface 22-1 of the protective member 22 and a vertex of the electrode assembly 20 may be coupled without a separate fastening structure or may be coupled by using an adhesive material if necessary. When an inner surface 22-1 of the protective member 22 comprises a shape corresponding to a vertex of the electrode assembly 20, the exposure of the vertex of the electrode assembly 20 to the outside of the protective member 22, and the separation of the protective member 22 from the vertex of the electrode assembly 20 can be prevented.

An outer surface 22-2 of the protective member 22 may comprise a curved shape. The description that an outer surface 22-2 of the protective member 22 comprises a curved shape means that the outer surface 22-2 of the protective member 22 that is in contact with the exterior material 21 has a bended shape without being angulated. When an outer surface 22-2 of the protective member 22 comprises a curved shape, a damage of a portion where the protective member 22 and the exterior material 21 are in contact with each other can be prevented, and leakage of an electrolyte solution, ignition of a secondary battery, or deterioration of the performance of a secondary battery can be prevented.

According to an Embodiment, the protective member 22 may comprise at least one of a thermoplastic resin, a thermosetting resin, a rubber resin, a non-conductive metal alloy, and a non-conductive ceramic. Specifically, the thermoplastic resin may be a mixture of at least one among an acrylic resin, a vinyl chloride resin, a vinyl acetate resin, a vinylacetyl resin, a methyl methacrylic resin, a polystyrene resin, a polyethylene resin, a polyamide resin, and a celluloid resin. The thermosetting resin may be a mixture of at least one among a phenol resin, a urea resin, a melamine resin, an alkyd resin, a polyester resin, an epoxy resin, a polyurethane resin, a silicon resin, and a furan resin. When the protective member 22 is formed of a non-conductive material such as a thermoplastic resin, a thermosetting resin, a rubber resin, a non-conductive metal alloy, and a non-conductive ceramic, the exterior material 21 of the electrode assembly 20 may not be damaged, and at the same time, a secondary battery may acquire insulation properties so that the performance thereof may not be deteriorated.

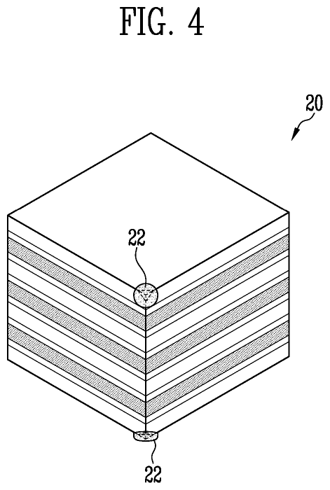

According to an Embodiment, the protective member 22 may be made of a transparent material. FIG. 4 is a schematic diagram of a structure of an electrode assembly in which a protective member made of a transparent material is formed according to one Embodiment of the present invention. Referring to FIG. 4, both an outer surface and an inner surface of the protective member 22 may be made of a transparent material. When the protective member 22 is made of a transparent material, a vertex of an electrode assembly 20 in which the protective member 22 is formed may be visually confirmed, and the protective member 22 included in the exterior material 21 may not cause an aesthetic problem.

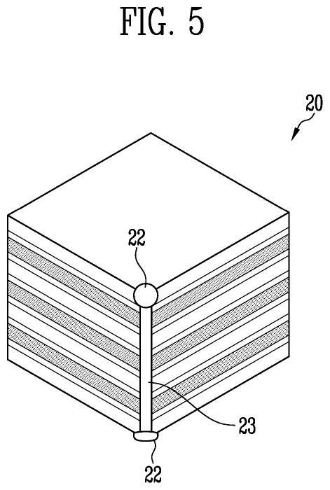

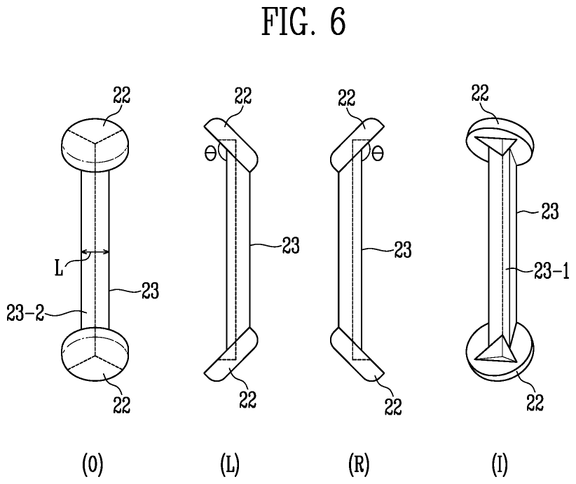

According to an Embodiment, the electrode assembly 20 may comprise a plurality of edges. According to an Embodiment, the electrode assembly 20 may further comprise a supplementary member 23 surrounding at least one edge among the plurality of edges. FIG. 5 is a schematic diagram of a structure of an electrode assembly in which a protective member and a supplementary member are formed according to one Embodiment of the present invention. FIG. 6 is an enlarged diagram of an outer surface, a left surface, a right surface, and an inner surface of a structure of a protective member and a supplementary member integrally configured according to one Embodiment of the present invention.

Referring to FIGS. 5 and 6, the secondary battery 200 may comprise a protective member 22 surrounding a vertex of the electrode assembly 20. In addition, the secondary battery 200 may further comprise a supplementary member 23 surrounding at least one edge among a plurality of edges. The supplementary member 23 may comprise an inner surface 23-1 and an outer surface 23-2. An inner surface of the supplementary member 23 may contact with an edge of the electrode assembly 20. An outer surface of the supplementary member 23 may contact the exterior material 21. When the supplementary member 23 is formed in the electrode assembly 20, the exterior material 21 may not be damaged due to a sharp edge of the electrode assembly 20 so that leakage of an electrolyte, ignition of a secondary battery, or deterioration of the performance of a secondary battery can be prevented.

According to an Embodiment, an inner surface 23-1 of the supplementary member 23 may comprise a shape corresponding to an edge. The description that an inner surface 23-1 of the supplementary member 23 has a shape corresponding to an edge of the electrode assembly 20 means that the inner surface 23-1 of the supplementary member 23 comprises a shape that can accommodate an edge of the electrode assembly 20. The description that an inner surface 23-1 of the supplementary member 23 comprises a shape corresponding to an edge of the electrode assembly 20 does not mean that the size and shape of the inner surface 23-1 of the supplementary member 23 are exactly the same as the size and shape of the electrode assembly 20. In addition, an inner surface 23-1 of the supplementary member 23 and an edge of the electrode assembly 20 may be coupled without a separate fastening structure or may be coupled by using an adhesive material if necessary. When an inner surface 23-1 of the supplementary member 23 comprises a shape corresponding to an edge of the electrode assembly 20, the exposure of the edge of the electrode assembly 20 to the outside of the supplementary member 23, and the separation of the supplementary member 23 from the edge of the electrode assembly can be prevented.

According to an Embodiment, the outer surface 23-2 of the supplementary member 23 may comprise a curved shape. The description that an outer surface 23-2 of the supplementary member 23 comprises a curved shape means that the outer surface 23-2 of the supplementary member 23 that is in contact with the exterior material 21 has a bended shape without being angulated. When an outer surface 23-2 of the supplementary member 23 comprises a curved shape, a damage of a portion where the supplementary member 23 and the exterior material 21 are in contact with each other can be prevented, and leakage of an electrolyte, ignition of a secondary battery, or deterioration of the performance of a secondary battery can be prevented.

According to an Embodiment, the protective member 22 and the supplementary member 23 may be integrally formed. The description that the protective member 22 and the supplementary member 23 are integrally formed means that the protective member 22 and the supplementary member 23 have a fixedly attached shape.

FIG. 6 shows the left L, right R, outer surface O, and inner surface I structures of the protective member 22 and the supplementary member 23, which are integrated. According to an Embodiment, the width L of the supplementary member 23 when the protective member 22 and the supplementary member 23 are viewed from the outer surface O is within a range of 5 mm to 50 mm, within a range of 5 mm to 40 mm, or within a range of 10 mm to 40 mm. When the width L of the supplementary member 23 satisfies said range, an exterior material that is in contact with an electrode assembly may not be damaged, the protective member 22 and the supplementary member 23 may not be easily separated from the electrode assembly 20, and the external deformation of the exterior material 21 and the reduction of the storage space of the electrode assembly 20 due to an increase of the volume of the protective member 22 and the supplementary member 23 can be minimized.

According to an Embodiment, the angle θ formed by the protective member 22 and the supplementary member 23 when the protective member 22 and the supplementary member 23 are viewed from the left (L) or right (R) may be greater than 90 degrees and less than 180 degrees, greater than 90 degrees and less than 160 degrees, or greater than 100 degrees and less than 160 degrees. When the angle θ formed by the protective member 22 and the supplementary member 23 satisfies said range, the protective member 22 and the supplementary member 23 may be easily coupled to an electrode assembly without a separate fastening structure or adhesive material, and may not be easily separated from the electrode assembly after being coupled.

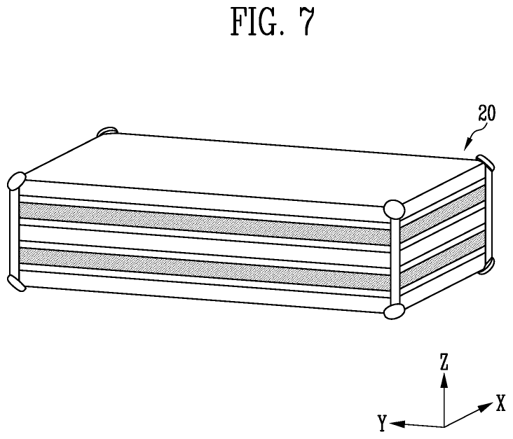

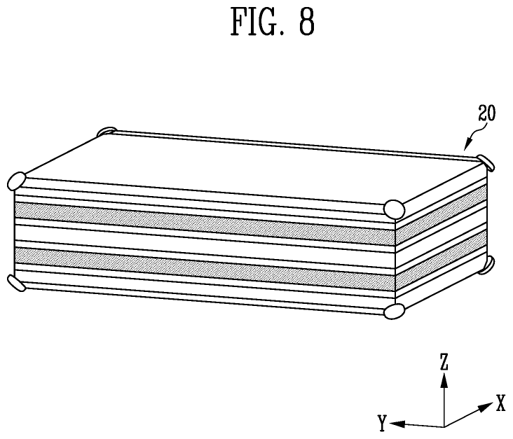

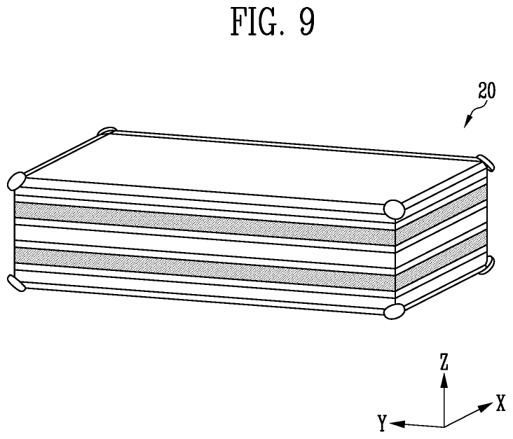

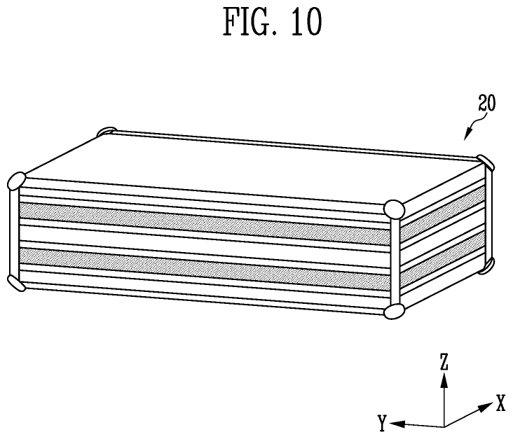

FIGS. 7 to 10 are schematic diagrams of various examples of the protective member 22 and the supplementary member 23 formed in the electrode assembly 20.

According to an Embodiment, the protective member 22 and the supplementary member 23 may have a structure surrounding an edge in the thickness direction Z of the electrode assembly 20. In addition, according to another Embodiment, the protective member 22 and the supplementary member 23 may have a structure surrounding an edge in the length direction Y of the electrode assembly 20. In addition, according to another Embodiment, a protective member 22 and a supplementary member 23 may have a structure surrounding edges in the width direction X and in the length direction Y of the electrode assembly 20. In addition, according to another Embodiment, a protective member 22 and a supplementary member 23 may have a structure surrounding edges in the thickness direction Z and in the length direction Y of the electrode assembly 20. FIGS. 7 to 10 show various structures of a protective member 22 and a supplementary member 23 formed in the electrode assembly 20, but a protective member 22 and a supplementary member 23 may be formed in various shapes on the electrode assembly 20 in addition to the structures shown in FIGS. 7 to 10.

According to an Embodiment, a supplementary member 23 may comprise at least one among a thermoplastic resin, a thermosetting resin, a rubber resin, a non-conductive metal alloy, and a non-conductive ceramic. The types of the thermoplastic resin and the thermosetting resin of the supplementary member 23 may be the same as the types of the thermoplastic resin and the thermosetting resin of the protective member 22 described above. The material of the supplementary member 23 may be the same as or different from the material of the protective member 22. In addition, when the supplementary member 23 and the protective member 22 are integrally formed, the material thereof may be the same, but is not limited thereto.

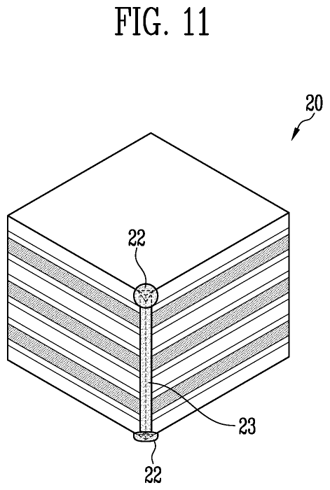

According to an Embodiment, the supplementary member 23 may be made of a transparent material. FIG. 11 is a schematic diagram of a structure of an electrode assembly in which a protective member made of a transparent material and a supplementary member made of a transparent material are formed according to one Embodiment of the present invention. Referring to FIG. 11, both an outer surface and an inner surface of the supplementary member 23 may be made of a transparent material. In addition, both the protective member 22 and the supplementary member 23 may be made of a transparent material. When the protective member 22 and the supplementary member 23 are made of a transparent material, an vertex and an edge of the electrode assembly 20 in which the protective member 22 and the supplementary member 23 are formed may be visually confirmed, and the protective member 22 and the supplementary member 23 included in the exterior material 21 may not cause an aesthetic problem.

A secondary battery according to an Embodiment of the present invention is disposed inside an exterior material and comprises a member surrounding a sharp outer surface of an electrode assembly to reduce the risk of the exterior material being damaged by a sharp outer surface of the electrode assembly. Therefore, leakage of an electrolyte, ignition of a secondary battery, or deterioration of the performance of a secondary battery can be prevented. In addition, a module comprising a secondary battery according to one Embodiment of the present invention as a unit cell and a device comprising the module as a power source have improved output characteristics, capacity, and stability.

What is claimed is:

1. A secondary battery comprising:
an electrode assembly;
an exterior material accommodating the electrode assembly, and
a protective member disposed inside the exterior material and surrounding a vertex of the electrode assembly.

2. The secondary battery according to claim 1,
wherein an inner surface of the protective member contacts with a vertex of the electrode assembly, and
wherein an outer surface of the protective member contacts with the exterior material.

3. The secondary battery according to claim 2,
wherein an inner surface of the protective member comprises a shape corresponding to the vertex.

4. The secondary battery according to claim 2,
wherein an outer surface of the protective member comprises a curved shape.

5. The secondary battery according to claim 1,
wherein the protective member comprises at least one among a thermoplastic resin, a thermosetting resin, a rubber resin, a non-conductive metal alloy, and a non-conductive ceramic.

6. The secondary battery according to claim 1,
wherein the protective member is made of a transparent material.

7. The secondary battery according to claim 1,
wherein the electrode assembly comprises a plurality of edges, and
wherein the secondary battery further comprises a supplementary member surrounding at least one edge among the plurality of edges.

8. The secondary battery according to claim 7,
wherein the protective member and the supplementary member are integrally formed.

9. The secondary battery according to claim 7,
wherein an inner surface of the supplementary member comprises a shape corresponding to the edge.

10. The secondary battery according to claim 7,
wherein an outer surface of the supplementary member comprises a curved shape.

11. The secondary battery according to claim 7,
wherein the width of the supplementary member is within a range of 5 mm to 50 mm.

12. The secondary battery according to claim 8,
wherein an angle formed by the protective member and the supplementary member is greater than 90 degrees and less than 180 degrees.

13. The secondary battery according to claim 8,
wherein the supplementary member surrounds an edge in the thickness direction of the electrode assembly.

14. The secondary battery according to claim 8,
wherein the supplementary member surrounds an edge in the length direction of the electrode assembly.

15. The secondary battery according to claim 8,
wherein the supplementary member surrounds an edge in the width direction of the electrode assembly and an edge in the length direction of the electrode assembly.

16. The secondary battery according to claim 8,
wherein the supplementary member surrounds an edge in the thickness direction of the electrode assembly and an edge in the length direction of the electrode assembly.

17. The secondary battery according to claim 7,
wherein the supplementary member comprises at least one among a thermoplastic resin, a thermosetting resin, a rubber resin, a non-conductive metal alloy, and a non-conductive ceramic.

18. The secondary battery according to claim 7,
wherein the supplementary member is made of a transparent material.
